(19) United States
(12) Patent Application Publication
(10) Pub. No.: US 2015/0205030 A1
(43) Pub. Date: Jul. 23, 2015

(54) PANEL LIGHT

(71) Applicant: Lextar Electronics Corporation, Hsinchu (TW)

(72) Inventor: Kuo-Chiang CHEN, Hsinchu County (TW)

(21) Appl. No.: 14/315,335

(22) Filed: Jun. 26, 2014

(30) Foreign Application Priority Data
Jan. 20, 2014 (TW) 103101999

(51) Int. Cl. F21V 8/00

(52) U.S. Cl. CPC G02B 6/009; G02B 6/0066; G02B 6/0035

(57) ABSTRACT

A panel light includes a light guide plate, L-typed frames and a light bar. The L-typed frames are connected with each other and surround edges of the light guide plate. Each of the L-typed frames includes a first board body, a second board body and a third board body. A gap is formed between the first and second board bodies. The third board body is connected between the first and second board bodies. An accommodating space is defined by the first, second and third board bodies. The edge of the light guide plate is inserted into the accommodating space between the first and second board bodies. The light bar is located on the third board body of one of the L-typed frames, and the light emitting direction of the light bar is toward a light incident surface of the light guide plate.

### RELATED APPLICATIONS

This application claims priority to Taiwan Application Serial Number 103101999, filed Jan. 20, 2014, which is herein incorporated by reference.

### BACKGROUND

1. Field of Invention

The present invention relates to a lighting device. More particularly, the present invention relates to a panel light.

2. Description of Related Art

Lighting devices are indispensable tools in our daily lives. Conventional lighting devices generally use traditional light bulbs or lamps as the light sources, in which fluorescent tubes, incandescent light bulbs, and halogen light bulbs are often used. Since the traditional incandescent bulbs consume a lot of electric power when emitting light, the lighting devices utilizing light-emitting diodes (LEDs) as light sources have become more and more popular in recent years. Compared with the incandescent bulbs, the LED light sources have the advantages of long operation life, low energy consumption, good shock resistance, and high brightness, etc.

A conventional panel light utilizing LEDs as light sources may be composed of an LED light bar, a back plate, a light guide plate, a diffusion board, frames, pressing strips, and auxiliary angle irons. When the LEDs on the light bar emit light, the light enters the light incident surface of the light guide plate, and exits from the light emitting surface of the light guide plate. The pressing strips may be fastened to the edge of the back plate by screws to position the light guide plate and the diffusion board. The assistant angle irons are fastened to the corners of the back plate, and two adjacent elongated frames may be connected by the auxiliary angle iron.

However, the conventional panel light has quite a lot of parts, and thus the assembly time and the material costs for the panel light is increased. Moreover, if the panel light is desired to be equipped with a suspending function, additional suspending elements (such as metal members with through holes or hooks) have to be arranged at the corners of the panel light. As a result, the assembly time and the material costs for the panel light may be further increased.

### SUMMARY

An aspect of the present invention is to provide a panel light.

According to an embodiment of the present invention, a panel light includes a light guide plate, plural L-typed frames, and a light bar. The light guide plate has a light emitting surface and a light incident surface which is adjacent to and perpendicular to the light emitting surface. The L-typed frames are connected with each other and surround edges of the light guide plate. Each of L-typed frames includes a first board body, a second board body, and a third board body. A gap is formed between the first and second board bodies. The third board body is connected between the first and second board bodies, such that an accommodating space is defined by the first, second and third board bodies. One of the edges of the light guide plate is inserted into the accommodating space between the first and second board bodies. The light bar is located on the third board body of one of the L-typed frames, and the light emitting direction of the light bar is toward the light incident surface.

In one embodiment of the present invention, two ends of each of the L-typed frames respectively have a protruding portion and a recessed portion, and the recessed portion is coupled to the protruding portion of another adjacent L-typed frame.

In one embodiment of the present invention, when the recessed portion of each of the L-typed frames is coupled to the protruding portion of another adjacent L-typed frame, the accommodating spaces of the coupled L-typed frames have the same cross-sectional sizes, and the accommodating spaces of the coupled L-typed frames are communicated with each other.

In one embodiment of the present invention, the recessed portion and the protruding portion of each of the L-typed frames respectively have through holes. When the recessed portion of each of the L-typed frames is coupled with the protruding portion of another adjacent L-typed frame, the through hole of the recessed portion and the through hole of the protruding portion are aligned to form a positioning hole. The panel light further includes fixing members. Each of the fixing members passes through one of the positioning holes, such that the L-typed frames are connected and fixed with each other.

In one embodiment of the present invention, the panel light further includes a back plate. The back plate is disposed under the light guide plate. An edge of the back plate is inserted into the accommodating space of one of the L-typed frames and abutted against the first and second board bodies. The back plate has a bottom plate and a sidewall. The sidewall is extended outward from an edge of the bottom plate.

In one embodiment of the present invention, the light bar is located on the sidewall and faces the light incident surface of the light guide plate.

In one embodiment of the present invention, the bottom plate of the back plate has a reflecting layer. The reflecting layer faces the light guide plate.

In one embodiment of the present invention, the panel light further includes a diffusion plate. The diffusion plate is located on a surface of the light guide plate facing away from the bottom plate. Two adjacent edges of the diffusion plate are positioned in the accommodating space of one of the L-typed frames.

In one embodiment of the present invention, the bottom plate has protruding ribs. The protruding ribs protrude toward the light guide plate.

In one embodiment of the present invention, the number of the L-typed frames is greater than or equal to two.

In one embodiment of the present invention, the number of the L-typed frames is four.

In the aforementioned embodiments of the present invention, since the first, second, and third board bodies define the accommodating space, the edge of the light guide plate may be located in the accommodating space. The L-typed frames connected with each other surround the edges of the light guide plate, such that some parts of a conventional panel light (e.g., pressing strips and auxiliary angle irons) can be omitted. As a result, the assembly time and the material cost for the panel light of the present invention may be reduced.

Another aspect of the present invention is to provide a panel light.

According to an embodiment of the present invention, a panel light includes elongated support frames, a light guide plate, a light bar, and L-typed frames. The light guide plate is located on the elongated support frames and surrounded by the elongated support frames. The light bar is located on one of the elongated support frames and faces a light incident surface of the light guide plate. Each of the L-typed frames is located on two of the elongated support frames that are adjacent to each other. An edge of the light guide plate and the light bar are positioned between the elongated support frames and the L-typed frames. The bending position of each of the L-typed frames has a suspending hole.

In one embodiment of the present invention, each of the L-typed frames includes a top plate and a sidewall. The top plate has a protruding portion. The suspending hole is at the protruding portion. The sidewall is perpendicularly adjacent to the top plate.

In one embodiment of the present invention, the protruding portions of the top plates protrude away from the elongated support frames.

In one embodiment of the present invention, the panel light further includes a diffusion plate. An edge of the diffusion plate is positioned between the elongated support frames and the L-typed frames. The light emitting surface of the light guide plate faces the diffusion plate.

In one embodiment of the present invention, the number of the L-typed frames is greater than or equal to two.

In one embodiment of the present invention, the number of the L-typed frames is four.

In the aforementioned embodiments of the present invention, the elongated support frames surround the light guide plate, and each L-typed frame is located on two of the elongated support frames that are adjacent to each other. Therefore, the edges of the light guide plate and the light bar can be positioned between the elongated support frames and the L-typed frames, such that some parts of a conventional panel light (such as pressing strips and auxiliary angle irons) can be omitted. Moreover, the bending position of the L-typed frame has a suspending hole, and thus the L-typed frame can be suspended without additional suspending elements. As a result, the assembly time and the material cost for the panel light of the present invention may be reduced.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 is a perspective view of a panel light according to an embodiment of the present invention;

FIG. 2 is an exploded view of the panel light shown in FIG. 1;

FIG. 3 is a cross-sectional view of the panel light taken along line shown in FIG. 1;

FIG. 4 is a partial enlarged view of a L-typed frame shown in FIG. 2;

FIG. 5 is schematic view of the panel light shown in FIG. 1 when fixing members are fastened to a bottom surface of the panel light;

FIG. 6 is a cross-sectional view of a panel light according to an embodiment of the present invention, in which the position of the cut line is the same that of FIG. 3;

FIG. 7 is a perspective view of a panel light according to an embodiment of the present invention;

FIG. 8 is an exploded view of the panel light shown in FIGS. 7; and

FIG. 9 is a perspective view of a L-typed frame shown in FIG. 8.

### DETAILED DESCRIPTION

Reference will now be made in detail, to the present embodiments of the invention, examples of which are illustrated in the accompanying drawings. Wherever possible, the same reference numbers are used in the drawings and the description to refer to the same or like parts.

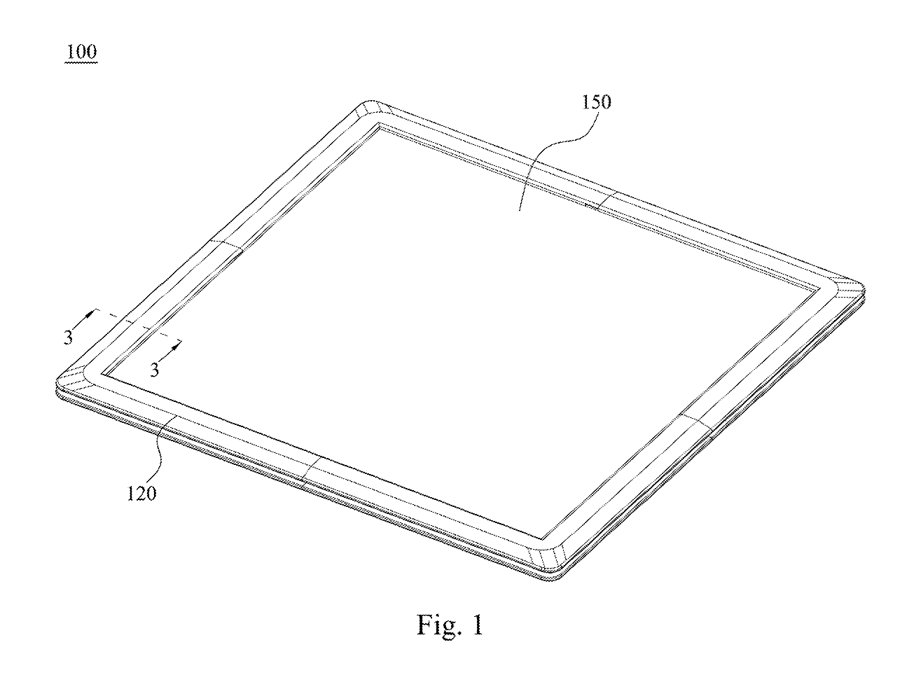

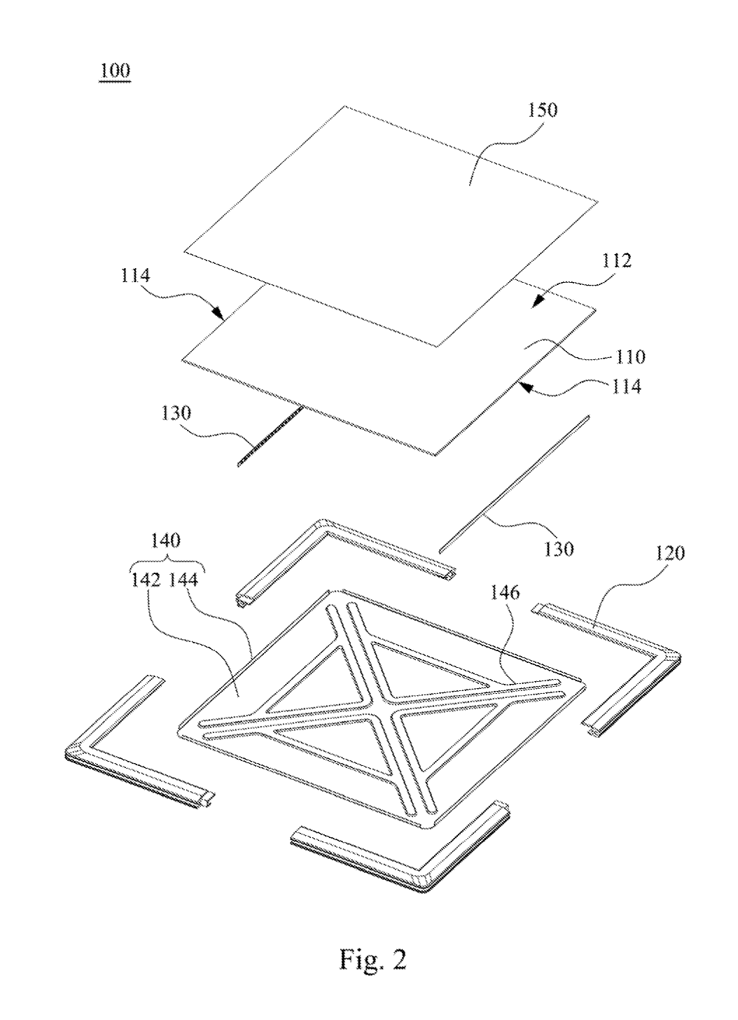

FIG. 1 is a perspective view of a panel light 100 according to an embodiment of the present invention. FIG. 2 is an exploded view of the panel light 100 shown in FIG. 1. As shown in FIG. 1 and FIG. 2, the panel light 100 includes a light guide plate 110, plural L-typed frames 120, and a light bar 130. The light guide plate 110 has a light emitting surface 112 and a light incident surface 114. The light incident surface 114 is perpendicularly adjacent to the light emitting surface 112. The L-typed frames 120 are connected with each other and surround edges of the light guide plate 110. In this embodiment, the number of the L-typed frames 120 and the number of the light bars 130 is two, but the present invention is not limited in this regard. The number of the L-typed frames 120 and the number of the light bars 130 may be varied as deemed necessary by designers. For example, the number of the L-typed frames 120 may be greater than or equal to two, and it is necessary only that the L-typed frames 120 can be connected with each other.

In this embodiment, the panel light 100 may further include a back plate 140 and a diffusion plate 150. The L-typed frames 120 are used to fix the side edges of the light guide plate 110, the back plate 140, and the diffusion plate 150. The back plate 140 is disposed under the light guide plate 110. The back plate 140 has a bottom plate 142 and a sidewall 144. The sidewall 144 is extended outward from the edge of the bottom plate 142. The bottom plate 142 has protruding ribs 146 protruding toward the light guide plate 110. The regions between every two protruding ribs 146 may be used to accommodate wires or electronic elements. The back plate 140 may be mounted on a ceiling or a wall, but the present invention is not limited in this regard. The diffusion plate 150 is located on the surface of the light guide plate 110 facing away from the bottom plate 142. That is to say, the diffusion plate 150 is located on the light emitting surface 112 of the light guide plate 110. When the light guide plate 110 emits light by utilizing the light bar 130, the diffusion plate 150 on the light emitting surface 112 may improve the uniformity of the light.

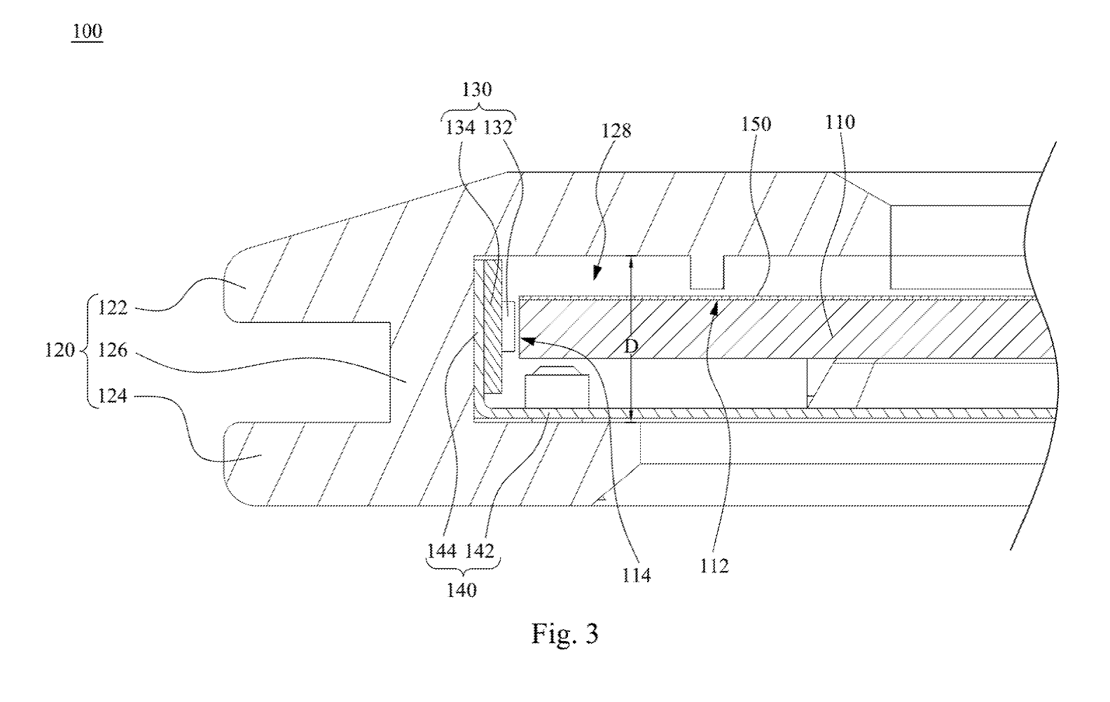

FIG. 3 is a cross-sectional view of the panel light 100 taken along line 3-3 shown in FIG. 1. As shown in FIG. 2 and FIG. 3, the L-typed frame 120 includes a first board body 122, a second board body 124, and a third board body 126. A gap D is formed between the first and second board bodies 122, 124. The third board body 126 is connected between the first and second board bodies 122, 124, such that an accommodating space 128 is defined by the first, second and third board bodies 122, 124, 126. The back plate 140 is abutted against the first and second board bodies 122, 124. Moreover, two adjacent edges of the light guide plate 110, two adjacent edges of the diffusion plate 150, and two adjacent edges of the back plate 140 are inserted into the accommodating space 128 of one L-typed frame 120, such that the edges of the light guide plate 110, the back plate 140, and the diffusion plate 150 can be positioned between the first and second board bodies 122, 124.

In this embodiment, depending on the design of the first, second and third board bodies 122, 124, 126, the appearance of the L-typed frame 120 is H-shaped, such that the strength of the L-typed frame 120 may be enhanced.

The light bar 130 is located on the third board body 126 of the L-typed frame 120, and the light emitting direction of the light bar 130 is toward the light incident surface 114 of the light guide plate 110. In this embodiment, the light bar 130 is located on the sidewall 144 of the back plate 140 and faces the light incident surface 114 of the light guide plate 110. The light bar 130 includes a light source 132 (such as an LED) and a board 134. The board 134 may be a printed circuit board, and may be electrically connected to an external power to provide a current for the light source 132. The back plate 140 may be made of a material including metal for transferring the heat generated by the light bar 130. When the light source 132 of the light bar 130 emits light, the light enters the light guide plate 110 from the light incident surface 114, and is emitted from the light emitting surface 112.

Compared with a conventional panel light, since the first, second, and third board bodies 122, 124, 126 of the L-typed frame 120 of the panel light 100 define the accommodating space 128, the edges of the light guide plate 110, the back plate 140, and the diffusion plate 150, and the light bar 130 may be placed in the accommodating space 128. The L-typed frames 120 connected with each other surround the edges of the light guide plate 110, and thus some parts of the conventional panel light (such as pressing strips and assistant angle irons) can be omitted. As a result, the assembly time and the material cost for the panel light 100 may be reduced.

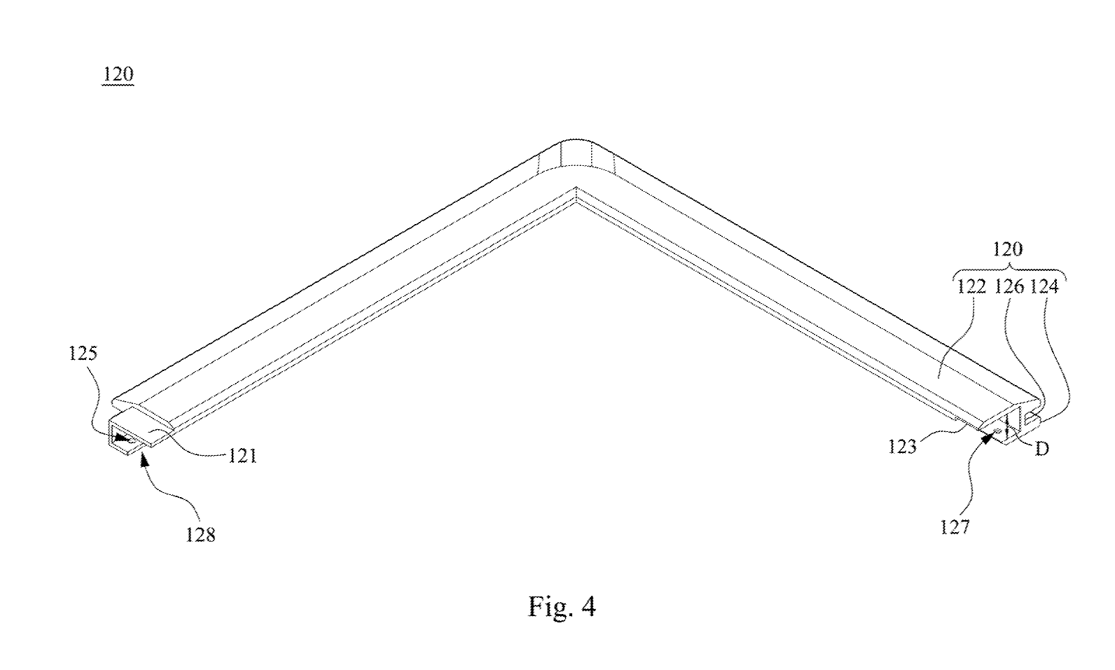

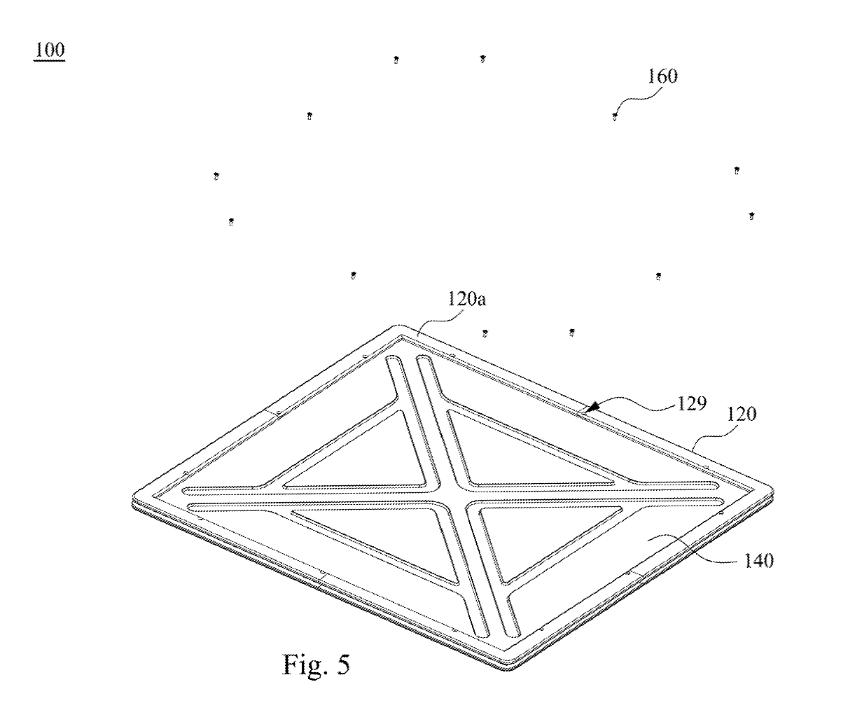

FIG. 4 is a partial enlarged view of the L-typed frame 120 shown in FIG. 2. FIG. 5 is schematic view of the panel light 100 shown in FIG. 1 when fixing members 160 are fastened to a bottom surface of the panel light 100. As shown in FIG. 4 and FIG. 5, two ends of the L-typed frame 120 respectively have a protruding portion 121 and a recessed portion 123. The protruding portion 121 has a through hole 125, and the recessed portion 123 has a through hole 127. During assembly of the panel light 100, the protruding portion 121 of the L-typed frame 120 can be coupled to the recessed portion 123 of another L-typed frame 120a that is adjacent to the L-typed frame 120. When the protruding portion 121 of the L-typed frame 120 is coupled to the recessed portion 123 of the adjacent L-typed frame 120a, the accommodating spaces 128 of the coupled L-typed frames 120 and 120a are communicated with each other, and the accommodating spaces 128 of the coupled L-typed frames 120 and 120a have the same cross-sectional sizes. Therefore, the edges of the light guide plate 110 (see FIG. 2) may be inserted into the communicated accommodating spaces 128 of the coupled L-typed frames 120 and 120a. Moreover, the through hole 125 of the L-typed frame 120 and the through hole 127 of the L-typed frame 120a are aligned to form a positioning hole 129. As a result, the fixing members 160 (such as screws) may respectively pass through the positioning holes 129 of the panel light 100, such that the L-typed frames 120, 120a are connected and fixed with each other.

It is to be noted that the connection relationships and the materials of the elements which have been described above will not be described again in the following description.

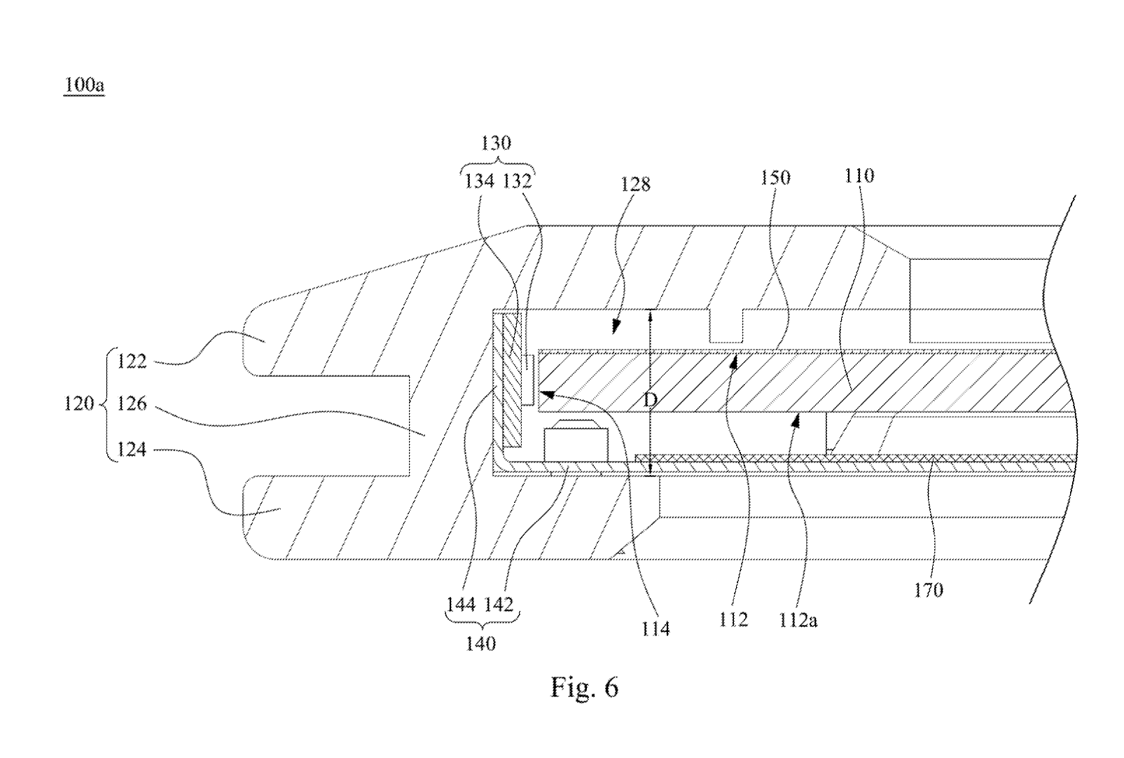

FIG. 6 is a cross-sectional view of a panel light 100a according to an embodiment of the present invention, in which the position of the cut line is the same that of FIG. 3. The panel light 100a includes the light guide plate 110, the L-typed frame 120, the light bar 130, the back plate 140, and the diffusion plate 150. The difference between this embodiment and the embodiment shown in FIG. 3 is that the bottom plate 142 of the back plate 140 of the panel light 100a has a reflecting layer 170, and the reflecting layer 170 faces the light guide plate 110. The light guide plate 110 has two opposite light emitting surfaces 112, 112a. When the light source 132 of the light bar 130 emits light, the light enters the light guide plate 110 from the light incident surface 114, and thereafter is emitted from the light emitting surfaces 112, 112a. The reflecting layer 170 is disposed under the light emitting surface 112a of the light guide plate 110, so as to reflect the light emitted by the light emitting surface 112a. As a result, the light-emitting efficiency of the panel light 100a is improved.

In this embodiment, the reflecting layer 170 may be a plate with high reflectivity, such as a plate of silver, aluminum, or high reflection plastic. The reflecting layer 170 may also be a coating material including silver, aluminum, mercury, or silver baking lacquer, but the present invention is not limited in this regard.

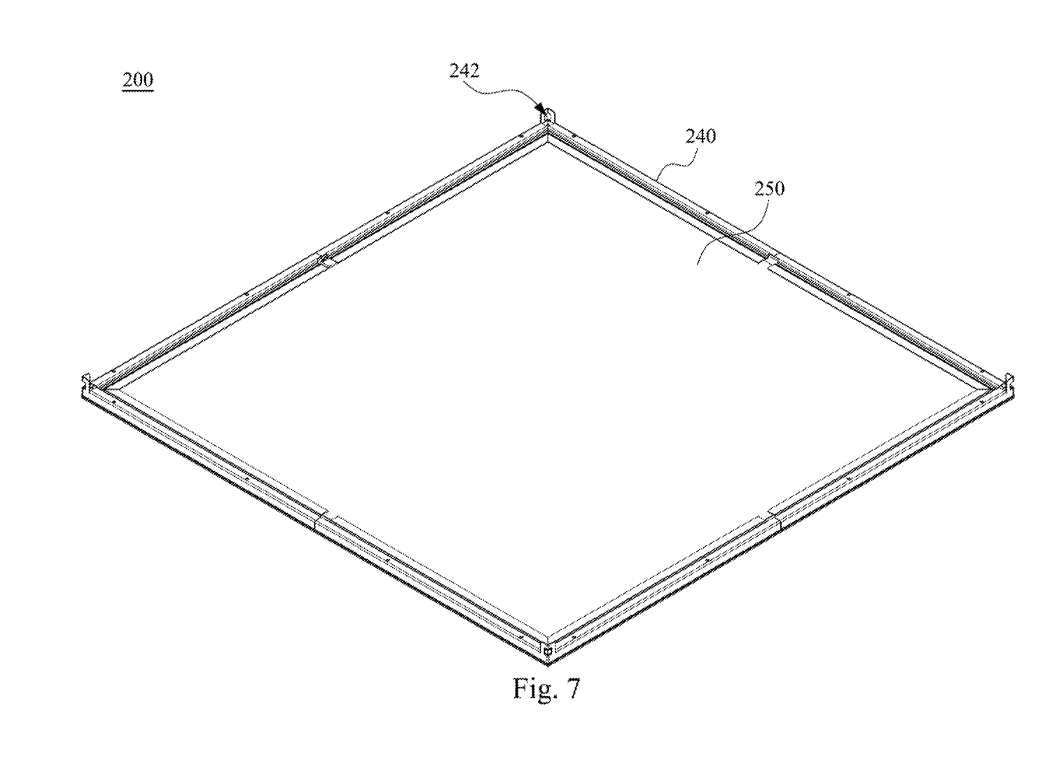

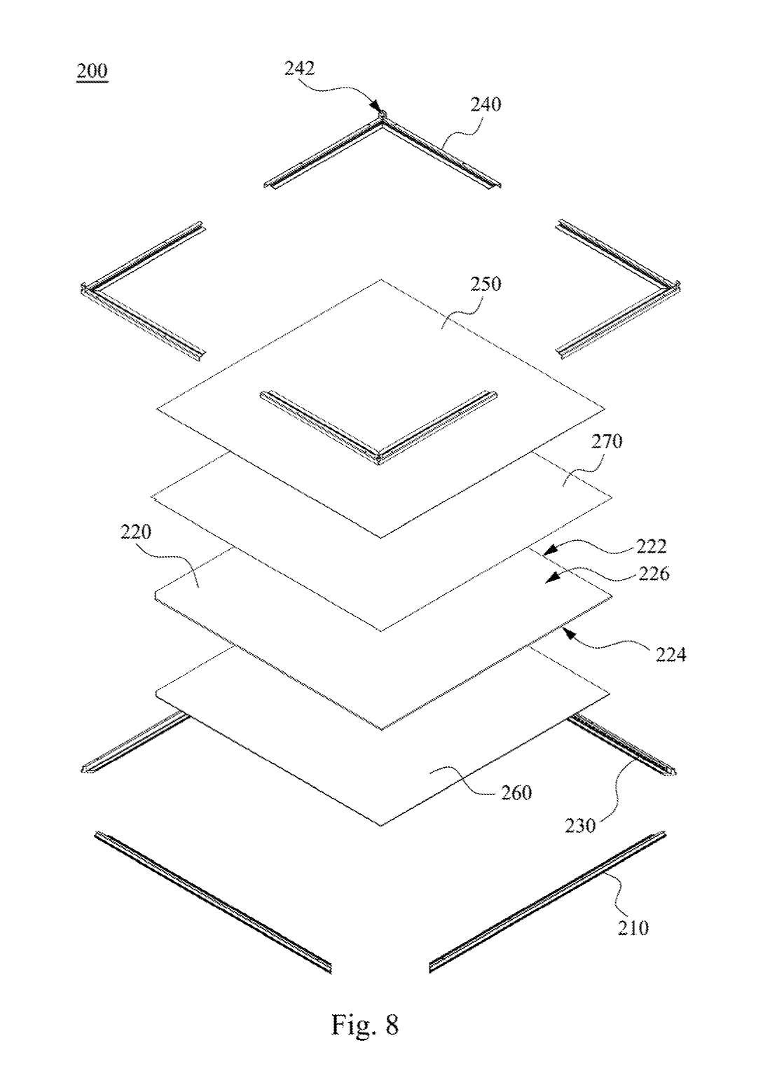

FIG. 7 is a perspective view of a panel light 200 according to an embodiment of the present invention. FIG. 8 is an exploded view of the panel light 200 shown in FIG. 7. As shown in FIG. 7 and FIG. 8, the panel light 200 includes elongated support frames 210, a light guide plate 220, a light bar 230, and L-typed frames 240. After the panel light 200 is assembled, the light guide plate 220 is located on the elongated support frames 210 and surrounded by the elongated support frames 210. The light guide plate 220 has a light incident surface 222 and light emitting surfaces 224, 226. The light bar 230 is located on the elongated support frame 210 and faces the light incident surface 222 of the light guide plate 220. Each of the L-typed frames 240 is located on two of the elongated support frames 210 that are adjacent to each other, and the edge of the light guide plate 220 and the light bar 230 are positioned between the elongated support frames 210 and the L-typed frames 240. The bending position of the L-typed frame 240 has a suspending hole 242. A hook or a suspending line connected to a ceiling may pass through the suspending hole 242, so as to suspend the panel light 200 from the ceiling, but the present invention is not limited to be suspended on the ceiling.

The number of the L-typed frames 240 may be greater than or equal to two. In this embodiment, the number of the L-typed frames 240 is four, but the present invention is not limited thereto, and the number of the L-typed frames 240 may be varied as deemed necessary by designers.

The panel light 200 may further include a back plate 250, a diffusion plate 260, and a reflection sheet 270. The edges of the back plate 250, the diffusion plate 260, and the reflection sheet 270 are positioned between the elongated support frames 210 and the L-typed frames 240. The light emitting surface 224 of the light guide plate 220 faces the diffusion plate 260. When the light bar 230 emits light, the light enters the light guide plate 220 from the light incident surface 222, and thereafter is emitted from the light emitting surfaces 224, 226. The reflection sheet 270 may reflect the light emitted by the light emitting surface 226 to improve the light-emitting efficiency of the panel light 200. Moreover, the diffusion plate 260 on the light emitting surface 224 may improve the uniformity of the light.

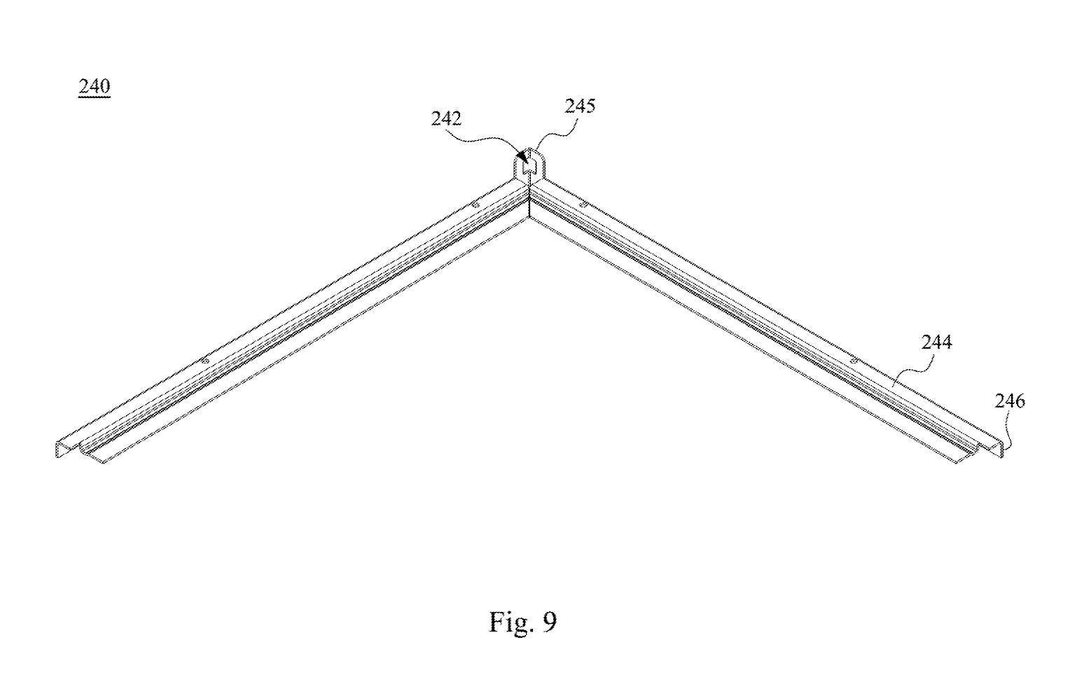

FIG. 9 is a perspective view of the L-typed frame 240 shown in FIG. 8. As shown in FIG. 8 and FIG. 9, the L-typed frame 240 includes a top plate 244 and a sidewall 246. The top plate 244 has a protruding portion 245, and the suspending hole 242 is located at the protruding portion 245. The sidewall 246 is perpendicularly adjacent to the top plate 244. The protruding portions 245 of the top plates 244 protrude in a direction facing away from the elongated support frames 210. The protruding portion 245 is a portion of the plate material forming the L-typed frame 240, and can be formed at the same time with the L-typed frame 240.

Compared with a conventional panel light, the elongated support frames 210 surround the light guide plate 220, and the L-typed frame 240 is located on two of the elongated support frames 210 that are adjacent to each other. Therefore, the edge of the light guide plate 220 and the light bar 230 can be positioned between the elongated support frames 210 and the L-typed frames 240, such that some parts of the conventional panel light (such as pressing strips and assistant angle irons) can be omitted. Moreover, the bending position of the L-typed frame 240 has the suspending hole 242, so that the L-typed frame 240 can be suspended without additional suspending elements. As a result, the assembly time and the material cost for the panel light 200 of the present invention may be reduced.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A panel ht comprising:
a light guide plate having a light emitting surface and a light incident surface, wherein the light incident surface is adjacent to and perpendicular to the light emitting surface;
a plurality of L-typed frames connected with each other and surrounding edges of the light guide plate, wherein each of the L-typed frames comprises:
a first board body
a second board body, wherein a gap is formed between the first and second board bodies; and
a third board body connected between the first and second board bodies, such that an accommodating space is defined by the first, second and third board bodies, and the edges of the light guide plate is inserted into the accommodating space between the first and second board bodies; and
a light bar located on the third board body of one of the L-typed frames, wherein a light emitting direction of the light bar is toward the light incident surface.

2. The panel light of claim 1, wherein two ends of each of the L-typed frames respectively have a protruding portion and a recessed portion, and the recessed portion is coupled to the protruding portion of another adjacent L-typed frame.

3. The panel light of claim 2, wherein when the recessed portion of each of the L-typed frames is coupled to the protruding portion of another adjacent L-typed frame, the accommodating spaces of the coupled L-typed frames have the same cross-sectional sizes, and the accommodating spaces of the coupled L-typed frames are communicated with each other.

4. The panel light of claim 3, wherein the recessed portion and the protruding portion of each of the L-typed frames respectively have through holes, and when the recessed portion of each of the L-typed frames is coupled to the protruding portion of another adjacent L-typed frame, the through hole of the recessed portion and the through hole of the protruding portion are aligned to form a positioning hole, and the panel light further comprises:
a plurality of fixing members, wherein each of the fixing members passes through one of the positioning holes, such that the L-typed frames are connected and fixed with each other.

5. The panel light of claim 1, further comprising:
a back plate disposed under the light guide plate, wherein an edge of the back plate is inserted into the accommodating space of one of the L-typed frames and abutted against the first and second board bodies, and the back plate has a bottom plate and a sidewall extended outward from an edge of the bottom plate.

6. The panel light of claim 5, wherein the light bar is located on the sidewall and faces the light incident surface of the light guide plate.

7. The panel light of claim 6, wherein the bottom plate of the back plate has a reflecting layer facing the light guide plate.

8. The panel light of claim 7, further comprising:
a diffusion plate located on a surface of the light guide plate facing away from the bottom plate, wherein two adjacent edges of the diffusion plate are positioned in the accommodating space of one of the L-typed frames.

9. The panel light of claim 7, wherein the bottom plate has a plurality of protruding ribs protruding toward the light guide plate.

10. The panel light of claim 1, wherein the number of the L-typed frames is greater than or equal to two.

11. The panel light of claim 10, wherein the number of the L-typed frames is four.

12. A panel light comprising:
a plurality of elongated support frames;
a light guide plate located on the elongated support frames and surrounded by the elongated support frames;
a light bar located on one of the elongated support frames and facing a light incident surface of the light guide plate; and
a plurality of L-typed frames, wherein each of the L-typed frames is located on two adjacent elongated support frames, and an edge of the light guide plate and the light bar are positioned between the elongated support frames and the L-typed frames, and a bending position of each of the L-typed frames has a suspending hole.

13. The panel light of claim 12, wherein each of the L-typed frames comprises:
a top plate having a protruding portion at which the suspending hole is located; and
a side all perpendicularly adjacent to the top plate.

14. The panel light of claim 13, wherein the protruding portions of the top plates protrude away from the elongated support frames.

15. The panel light of claim 12, further comprising:
a diffusion plate, wherein an edge of the diffusion plate is positioned between the elongated support frames and the L-typed frames, and a light emitting surface of the light guide plate faces the diffusion plate.

16. The panel light of claim 12, wherein the number of the L-typed frames is greater than or equal to two.

17. The panel light of claim 16, wherein the number of the L-typed frames is four.
